(19) United States
(12) Patent Application Publication
(10) Pub. No.: US 2011/0222291 A1
(43) Pub. Date: Sep. 15, 2011

(54) LIGHTING FIXTURE WITH INTEGRATED JUNCTION-BOX

(76) Inventor: Chunghang Peng, Walnut, CA (US)

(21) Appl. No.: 12/723,818

(22) Filed: Mar. 15, 2010

(51) Int. Cl. F21V 29/00; F21V 15/01; F21V 17/02

(52) U.S. Cl. 362/294; 362/362; 362/373; 362/368

(57) ABSTRACT

A lighting fixture is disclosed that includes an integrated junction box (J-box). The integration of the J-box substantially facilitates the electrical wiring of such lighting fixtures. It also operates as a heat sink to dissipate unwanted thermal energy from the light source and ballast. The lighting fixture includes a ballast for generating a drive signal for the light source. At least a portion of the ballast may be situated within the J-box. The lighting fixture may also include, between the light source and the emitting end of the fixture, at least one diffuser, a reflector, and a lens. The lighting fixture may include swivelable clamps and a support ring for securing the fixture onto a support member, such as a ceiling. For thermal control, the lighting fixture may further include a heat sink thermally coupled to the light source, and cooling fans thermally coupled to the heat sink.

### FIELD

This invention relates generally to lighting fixtures for commercial and residential applications, and in particular, to a lighting fixture that includes an integrated junction-box (commonly referred to also as a J-box).

### BACKGROUND

Lighting fixtures used in commercial and residential applications are typically mounted on the ceiling, although some fixtures are mounted on the walls as well. These lighting fixtures usually require at least two wires to supply electrical power to the light source. Typically, in commercial and residential applications, it is required that all electrical wiring for a lighting fixture must be routed through a junction-box (J-box) that is assigned to that particular lighting fixture. This is better explained with reference to the following example.

FIG. 1 illustrates a diagram of an exemplary conventional lighting fixture electrical network 100 situated in a commercial or residential building. In this example, the building includes a floor 152, walls 154, and ceiling 156. Further, in this example, the ceiling 156 includes two openings 158 and 160 through which two lighting fixtures 102 and 104 respectively extend. A first set of electrical wiring 106 for the building may be routed from the exterior to the interior of the building through initially one of the walls 154.

The first electrical wiring set 106 may be routed to a J-box 108 that is designated to lighting fixture 102. A second set of electrical wiring 110, which is electrically connected to the first set 106 via the J-box 108, is routed from the J-box 108 to the lighting fixture 102. A third set of electrical wiring 112, which is also electrically connected to the first set 106, is routed from the J-box 108 to another J-box 118 that is designated for lighting fixture 104. A fourth set of electrical wiring 116, which is electrically connected to the first set 106 via the J-boxes 118 and 106, is routed from the J-box 118 to the lighting fixture 104.

The lighting fixture electrical network 100 is merely an example, and it shall be understood, that the network may vary extensively. However, as noted in this example, the electrical network 100 is relatively complex. This is because electrical wiring for each lighting fixture must be routed by way of a separate J-box. This requirement generally presents lots of drawbacks. For instance, the wiring is complex, for example, requiring four sets of electrical wirings for two lighting fixtures. This typically results in substantial amount of labor to properly wire the lighting fixtures, and consequently translates to higher costs. Additionally, the complexity of the wiring may lead to electrical reliability problems.

### SUMMARY

An aspect of the invention relates to a lighting fixture that includes an integrated junction box. The integrated junction box substantially simplifies the electrical wiring of one or more of such lighting fixtures in a commercial or residential setting. This is because the lighting fixture eliminates the need to route wires from a separate junction box to the fixture. The reduction in the complexity of the electrical wiring translates to reduced labor, time, and expense in the installation of such lighting fixtures. Additionally, the reliability of the lighting fixtures and its electrical wiring network is substantially improved.

In particular, the lighting fixture may comprise a light source (e.g., a light emitting diode (LED) based light source), a housing enclosing the light source, and a junction box mechanically coupled to or integrated with the housing. The lighting fixture may further comprise a ballast adapted to generate a drive signal for the light source. In another aspect, at least a portion of the ballast is situated within the junction box. For thermal control, the lighting fixture may also include a heat sink thermally coupled to the light source, and a plurality of cooling fins thermally coupled to the heat sink.

In another aspect, the lighting fixture may comprise one or more diffusers for scattering the light at distinct locations within the fixture; a reflector adapted to guide and focus the scattered light towards an emitting end of the lighting fixture; a lens situated optically between the second diffuser and the emitting end; and a trim situated around the perimeter of the lens. In another aspect, the trim and the reflector may be an integrated element. In yet another aspect, a support ring may be coupled to a lower end of the housing, and used to secure the fixture onto a support member (e.g., a ceiling). In still another aspect, the support ring includes a first coupling member, and the trim includes a second coupling member. The first and second coupling members are adapted to be securely mated by rotating the trim relative to the support ring.

In another aspect, the lighting fixture housing comprises a plurality of swivelable clamps, wherein the clamps and the support ring are configured to clamp to the support member to secure the fixture on the member. In yet another aspect, the swivelable clamps are adapted to be in an extended position to secure the fixture onto the support member. In still another aspect, the swivelable clamps are adapted to be in a retracted position to allow at least a portion of the fixture housing to be inserted through an opening in the support member.

In another aspect, the junction box operates at least in part as a heat sink to more efficiently remove heat away from the light source and associated electronics (e.g., a ballast). This reduces the operating temperature of the light source and associated electronics, which enhances the reliability of the lighting fixture.

Other aspects, advantages and novel features of the present invention will become apparent from the following detailed description of the invention when considered in conjunction with the accompanying drawings.

### BRIEF DESCRIPTION OF THE DRAWINGS

FIG. 1 illustrates a diagram of an exemplary conventional lighting fixture electrical network.

FIG. 2 illustrates a perspective view of an exemplary lighting fixture in accordance with an embodiment of the invention.

FIG. 3 illustrates a side view of the exemplary lighting fixture with swivelable clamps retracted in accordance with another embodiment of the invention.

FIG. 4 illustrates a side view of the exemplary lighting fixture with swivelable clamps extended in accordance with another embodiment of the invention.

FIG. 5 illustrates an internal view of the exemplary lighting fixture in accordance with another embodiment of the invention.

FIG. 6A illustrates a side view of an exemplary attachment mechanism for attaching a trim to a support ring in an almost-attached position in accordance with another embodiment of the invention.

FIG. 6B illustrates a side view of the exemplary attachment mechanism for attaching the trim to the support ring in the attached position in accordance with another embodiment of the invention.

FIG. 7 illustrates a block diagram of an exemplary lighting fixture in accordance with another embodiment of the invention.

FIG. 8 illustrates a perspective view of a second exemplary lighting fixture in accordance with another embodiment of the invention.

FIG. 9 illustrates an internal view of the second exemplary lighting fixture in accordance with another embodiment of the invention.

FIG. 10 illustrates an internal view of a third exemplary lighting fixture in accordance with another embodiment of the invention.

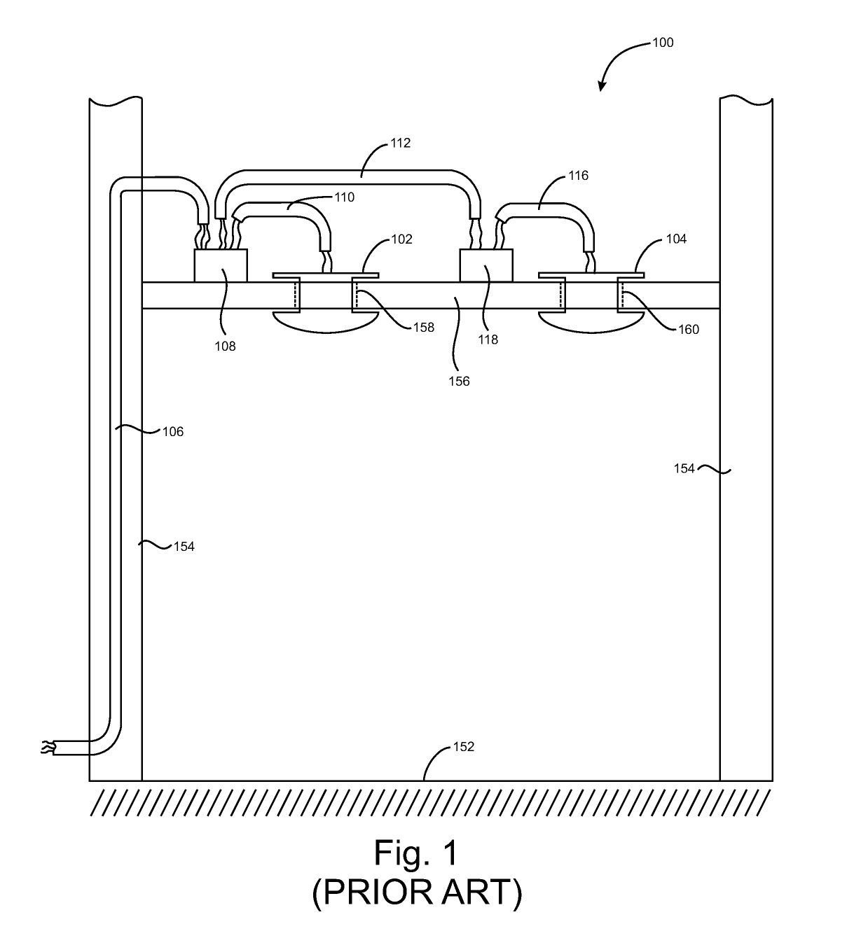

### DETAILED DESCRIPTION OF THE EXEMPLARY EMBODIMENTS

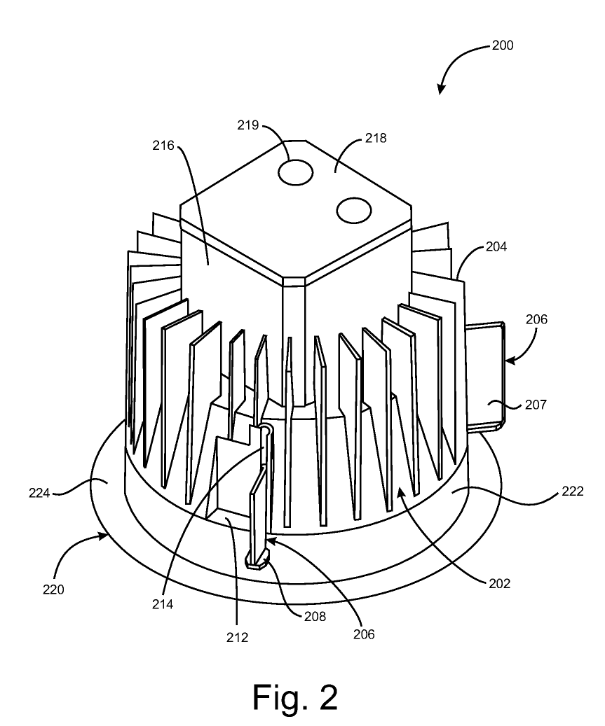

FIG. 2 illustrates a perspective view of an exemplary lighting fixture 200 in accordance with an embodiment of the invention. In summary, the lighting fixture 200 comprises a housing that includes an integrated junction-box (J-box). This feature substantially simplifies the electrical wiring for these lighting fixtures, and reduces labor and costs, as well as improves the reliability of the electrical wiring network. Additionally, as discussed in more detail below, the integrated J-box is further configured to house at least a portion of a ballast that drives the light source of the lighting fixture, and may also serve at least in part as a heat sink for the lighting fixture.

In particular, the lighting fixture 200 comprises a main housing 202 for housing many components of the fixture, as discussed in more detail below. The main housing 202 may be configured to have a plurality of vertically-oriented cooling fins 204 in order to efficiently dissipate heat generated by the light source and related electronics. The main housing 202 may further include a plurality of swivelable clamps 206 for securely attaching the lighting fixture to a support member, such as a ceiling, as discussed in more detail below. The clamps 206 may be substantially equally spaced around the circumference of the cone-shaped housing 202. In this example, the main housing 202 includes three clamps 206 (only two being shown in FIG. 2).

Each swivelable clamp 206 includes a vertical member 207 having an edge portion situated longitudinally within a vertically-oriented groove 214 of the main housing 202. The clamp 206 is configured to be moved vertically along the groove 214, and also rotate about the longitudinal axis of the groove. Each clamp 206 includes a horizontal flange 208 attached to the lower portion of the vertical member 207. When the clamp 206 is situated in its lowest position along the groove 214, the flange 208 makes contact with a support ring 220 of the lighting fixture 200, and ensures that the clamp extends substantially radially outward from the main housing 202 (e.g., the clamp's extended position). When the clamp 206 is in its highest position along the groove 214, the clamp is able to rotate such that the flange 208 is disposed on a ledge 212 of the main housing 202 (e.g., the clamp's retracted position).

The support ring 220 includes a vertical portion 222 that extends below the lower portion of the cone-shaped main housing 202. Additionally, the support ring 220 includes a horizontal portion 224 that extends radially outward from the lower end of the vertical portion 222 of the support ring. As discussed in more detail below, the lighting fixture 200 is secured to the ceiling by the lower side of the ceiling resting on the horizontal portion 224 of the support ring 220, and the flanges 208 of the clamps 206 resting on the upper side of the ceiling when the clamps are in their extended position. In other words, the flanges 208 and horizontal portion 224 clamp onto the ceiling.

As discussed above, the lighting fixture 200 further includes a J-box 216 that is integrated or mechanically coupled to the main housing 202. More specifically, an upper portion of the main housing 202 includes a square or rectangular shaped opening. The square- or rectangular J-box is situated over and aligned with the opening. As shown, the J-box 216 further includes a removable cover 218 to allow access to the inside of the J-box for electrical wiring purpose, and to cover the J-box during normal use, handling, and transportation. Additionally, the cover 218 may include one or more openings or ports 219 through which electrical wiring may extend. As discussed in more detail below, the J-box further houses at least a portion of a ballast that drives the light source of the lighting fixture 200. The integrated J-box may further be used as the heat sink for the ballast and light source.

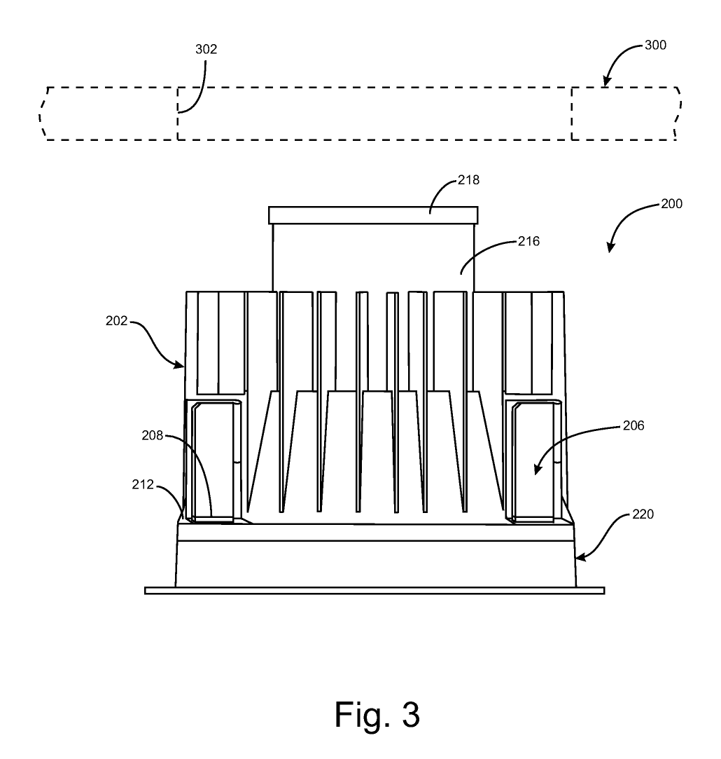

FIG. 3 illustrates a side view of the exemplary lighting fixture 200 with swivelable clamps 206 retracted in accordance with another embodiment of the invention. Prior to mounting the lighting fixture 200 on a ceiling 300, the lighting fixture is aligned vertically below an opening 302 in the ceiling, as shown. Additionally, in this position, the swivelable clamps 206 are placed in their retracted position so that they do not make contact with the ceiling 300 during the insertion of the fixture through the opening 302 in the ceiling. As previously discussed, the swivelable clamps 206 are placed in the retracted position by sliding the clamps upward to their maximum vertical position, and then rotating the clamps clockwise (as seen from above) until their flanges 208 are situated over the respective ledges 212 of the main housing 202.

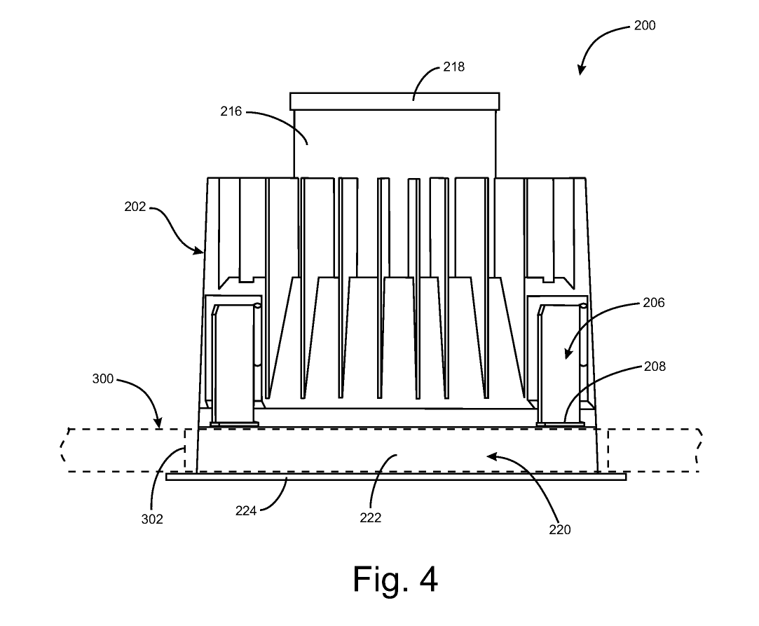

FIG. 4 illustrates a side view of the exemplary lighting fixture 200 with swivelable clamps 206 extended in accordance with another embodiment of the invention. Once the main housing 202 including the J-box 216 and cover 218 are situated above the ceiling 300, and the lower side of the ceiling makes contact with the horizontal portion 224 of the support ring 220, the swivelable clamps 206 are positioned in their extended position where the flanges 208 of the clamps 206 make contact to the upper side of the ceiling 300. In this position, the ceiling 300 is sandwiched between the horizontal portion 224 of the support ring 220 and the flanges 208 of the respective clamps 206. Thus, this clamps the lighting fixture 200 to the ceiling 300. The height of the vertical portion 222 of the support ring 220 may be selected to achieve a desired recess for the lighting fixture 200.

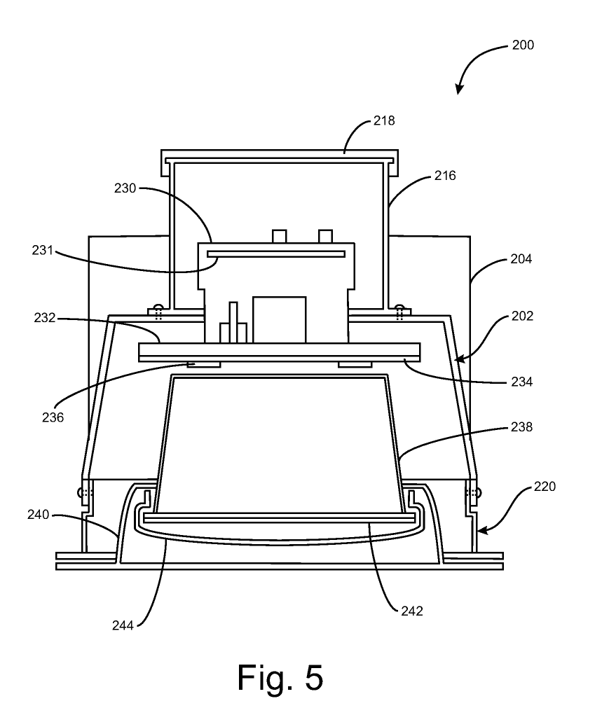

FIG. 5 illustrates of an internal view of the exemplary lighting fixture 200 in accordance with another embodiment of the invention. From the top to the bottom, the lighting fixture 200 comprises the J-box 216 including its cover 218, a ballast 230 including a power printed circuit board (PCB) 231, a heat sink 232, a light source PCB 234, a light source 236 (e.g., light emitting diodes (LEDs)), a reflector 238, a trim 240, a diffuser lens 242, and a lens 244.

As shown, the J-box 216 houses at least a portion of the ballast 230, as well as the electrical wiring (not shown) typically housed in a J-box. The power PCB 231 of the ballast 230 generates a drive signal for the light source 236. The heat sink 232 is thermally coupled to the light source PCB 234 to assists in removing heat from the light source 236. Additionally, the heat sink 232 may be thermally coupled to the cooling fins 204 and the J-box 216 to improve the thermal control of the lighting fixture 200. The light source 236, which is mounted on the PCB 234, and may be LED based, generates the light of the lighting fixture 200. The reflector 238 assists in guiding and focusing the light downward towards the emitting end of the fixture 200. The diffuser lens 242 further scatters the light exiting the reflector 238. The lens 244 guides the light emanating from the fixture 200, as well as provides a decorative cover for the internal components of the fixture. The trim 240 provides a decorative trim around the lens 244.

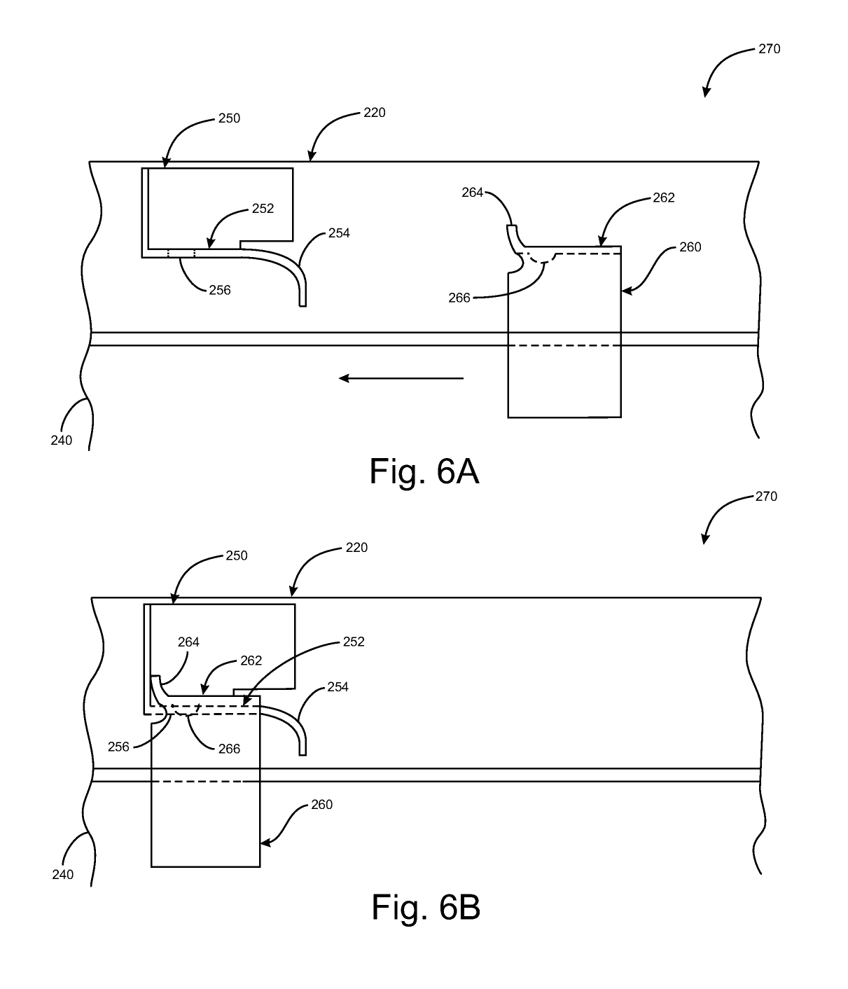

FIG. 6A illustrates a side view of an exemplary attachment mechanism 270 for attaching the trim 240 to the support ring 220 in an almost-attached position in accordance with another embodiment of the invention. The attachment mechanism 270 includes a first coupling member 250 which is mounted on an internal surface of the support ring 220. The first coupling member 250 includes a first contact member 252 having a first inclined surface 254 and a thru-hole 256. The attachment mechanism 270 further includes a second coupling member 260 which is mounted on an internal surface of the trim 240. The second coupling member 260 includes a second contact member 262 having a second inclined surface 264 and a protrusion 266. As shown, the trim 240 is inserted coaxially upward into the lighting fixture 200 until the first and second contact members 252 and 262 are substantially horizontally aligned, but angularly spaced apart. The trim 240 is then rotated (as indicated by the arrow) in order to mate the second coupling member 260 with the first coupling member 250.

FIG. 6B illustrates a side view of the exemplary attachment mechanism 270 for attaching the trim 240 to the support ring 220 in the attached position in accordance with another embodiment of the invention. During the coupling of the second coupling member 260 to the first coupling 250, the lower side of the second contact member 262 slides along the upper side of the first contact member 252. The first and second inclined surfaces 254 and 264 assist in the smooth mating of the first and second contact members 252 and 262. As shown, when the first and second coupling members 250 and 260 are completely mated, the protrusion 266 of the second coupling member 260 registers with the thru-hole 256 of the first coupling member 250, thereby locking the members together. Unlocking the second coupling member 260 from the first coupling member 250 entails rotating the trim 240 in a direction opposite the arrow shown in FIG. 6A.

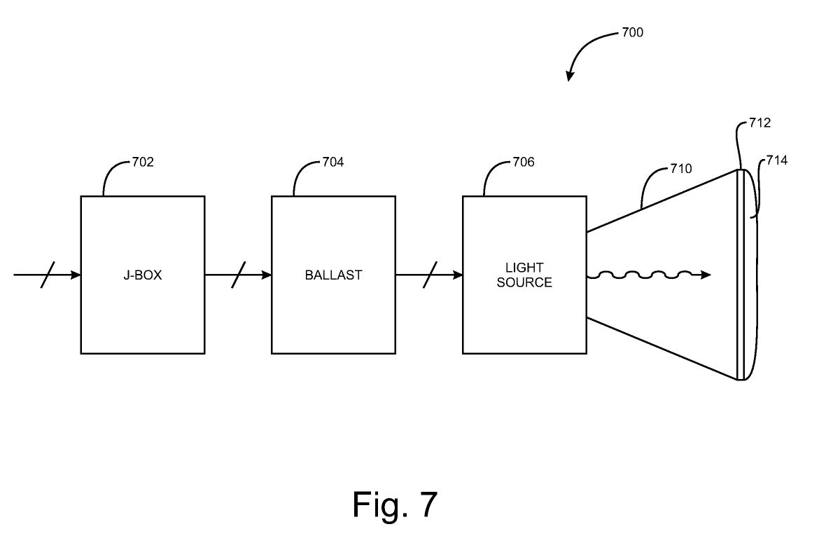

FIG. 7 illustrates a block diagram of the exemplary lighting fixture 700 in accordance with another embodiment of the invention. Schematically, the lighting fixture 700 comprises a J-box 702, a ballast 704, a light source 706 (e.g., an LED based light source), a reflector 710, a light diffuser 712, and a lens 714, all of which are situated as part of an integrated enclosure. The J-box 702 receives external electrical wires for supplying power to the ballast 704 and light source 706. Within the J-box 702, an additional set of electrical wires electrically couple the external wires to the ballast 702 and light source 706. The ballast 704 generates a drive signal for the light source 706.

The light source 706 generates the light based on the drive signal. The reflector 710 guides and focuses the light towards the emitting end of the lighting fixture 700. The light diffuser 712 performs a scattering of the light near the emitting end of the lighting fixture 700. And, the lens 714 guides the light, while at the same time provides a decorative cover to protect the internal components of the lighting fixture 700.

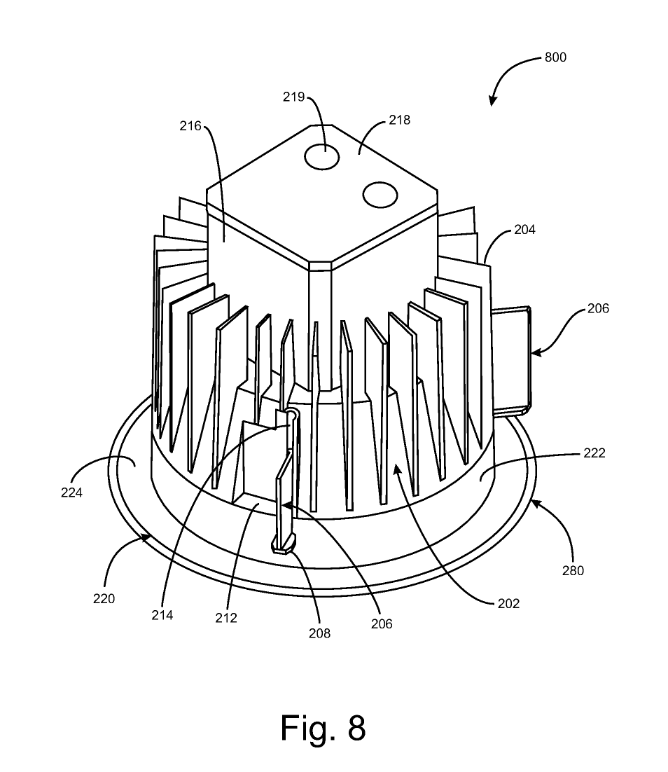

FIG. 8 illustrates a perspective view of a second exemplary lighting fixture 800 in accordance with another embodiment of the invention. In summary, the lighting fixture 800 is similar to that of lighting fixture 200, and includes many of the same elements as noted by the same reference numbers. Thus, the detail discussion of these common elements has been provided above. As discussed in more detail below, the lighting fixture 800 differs from that of lighting fixture 200 in that fixture 800 includes an integrated reflector and trim, and further includes a metal ring around the peripheral portion of the lens. As depicted in FIG. 8, a flange portion of the integrated reflector-trim 280 protrudes radially beyond the horizontal portion 224 of the support ring 220.

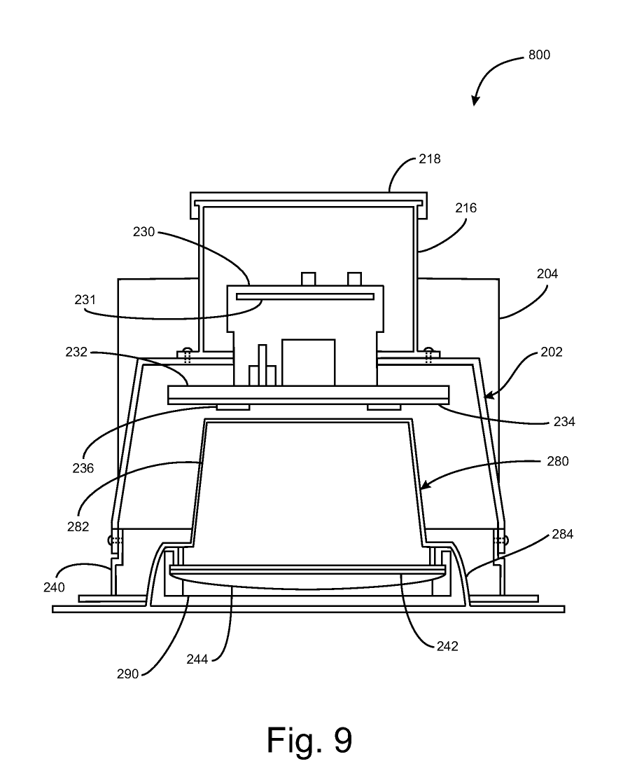

FIG. 9 illustrates of an internal view of the second exemplary lighting fixture 800 in accordance with another embodiment of the invention. As noted, the lighting fixture 800 includes an integrated reflector-trim 280 comprising a reflector portion 282 and a trim portion 284. The functions of the reflector portion 282 and trim portion 284 are substantially the same as the reflector 238 and trim 240 of lighting fixture 200. Additionally, the lighting fixture 800 further comprises a metallic ring 290 situated around the peripheral portion of the lens 244. The metallic ring 290 provides additional support for the lens 244, and also provides an additional decorative trim around the lens 244.

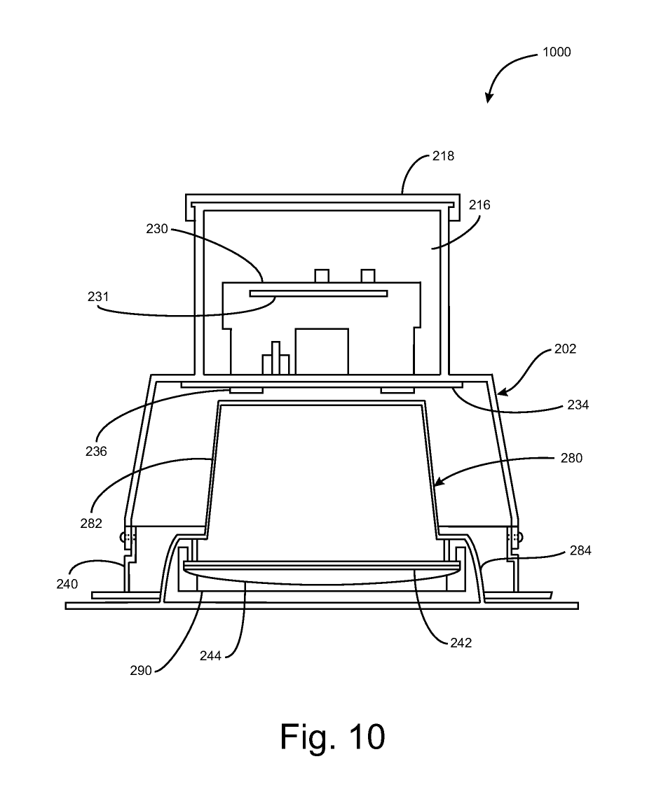

FIG. 10 illustrates a perspective view of a third exemplary lighting fixture 1000 in accordance with another embodiment of the invention. In summary, the lighting fixture 1000 is similar to that of lighting fixture 800, and includes many of the same elements as noted by the same reference numbers. Thus, the detail discussion of these common elements has been provided above. The lighting fixture 800 differs from that of lighting fixture 200 in that the light source PCB 234 is directly coupled to the main housing 202. Additionally, the J-box 216 is fabricated as part of the main housing 202. Thus, in this manner, the J-box 216 operates as a heat sink to efficiently remove heat from the light source 236, PCB 234, and the ballast 230. In this embodiment, the internal heat sink 232 may not be needed as well as the cooling fins 204 of the main housing 202, although these items may optionally be included in the fixture 1000.

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A lighting fixture, comprising:
a light source;
a housing enclosing the light source; and
a junction box mechanically coupled to or integrated with the housing.

2. The lighting fixture of claim 1, further comprising a ballast adapted to generate a drive signal for the light source.

3. The lighting fixture of claim 2, wherein at least a portion of the ballast is situated within the junction box.

4. The lighting fixture of claim 1, wherein the light source comprises a light emitting diode (LED)-based light source.

5. The lighting fixture of claim 1, further comprising:
a heat sink thermally coupled to the light source; and
a plurality of cooling fins thermally coupled to the heat sink.

6. The lighting fixture of claim 1, wherein the junction box operates as a heat sink for the light source.

7. The lighting fixture of claim 6, further comprising a reflector adapted to guide and focus the scattered light towards an emitting end.

8. The lighting fixture of claim 7, further comprising a diffuser for scattering light received from the reflector and the light source.

9. The lighting fixture of claim 8, further comprising a lens situated optically between the second diffuser and the emitting end.

10. The lighting fixture of claim 9, further comprising a trim situated around a perimeter of the lens.

11. The lighting fixture of claim 10, wherein the trim and the reflector are integrated.

12. The lighting fixture of claim 10, further comprising a support ring mechanically coupled to the housing, wherein the support ring comprises a first coupling member, wherein the trim comprises a second coupling member, and wherein the first and second coupling member are adapted to couple together by rotation of the trim relative to the support ring.

13. The lighting fixture of claim 1, wherein the housing comprises a plurality of swivelable clamps.

14. The lighting fixture of claim 13, further comprising a support ring mechanically coupled to the housing, wherein the plurality of swivelable clamps and the support ring are adapted to clamp to a support member.

15. The lighting fixture of claim 14, wherein the swivelable clamps are adapted to be in an extended position when the fixture is secured to the support member.

16. The lighting fixture of claim 15, wherein the swivelable clamps are adapted to be in a retracted position to allow at least a portion of the housing to be inserted through an opening in the support member.

17. A lighting fixture, comprising:
a light source; and
a housing enclosing the light source, wherein the housing includes a junction box portion.

18. The lighting fixture of claim 17, further comprising a ballast adapted to generate a drive signal for the light source, wherein the ballast is situated at least partially within the junction box portion of the housing.

19. A lighting fixture, comprising:
a light source; and
a junction box mechanically coupled to the light source.

20. The lighting fixture of claim 19, further comprising a ballast adapted to generate a drive signal for the light source, wherein the ballast is situated at least partially within the junction box.
